(19) United States
(12) Patent Application Publication
(10) Pub. No.: US 2011/0007348 A1
(43) Pub. Date: Jan. 13, 2011

(54) PROCESS DETERMINING APPARATUS, IMAGE PROCESSING APPARATUS, PROCESS DETERMINING SYSTEM, COMPUTER READABLE MEDIUM STORING PROGRAM, AND PROCESS DETERMINING METHOD

(75) Inventor: Wataru YAMAIZUMI, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/695,696

(22) Filed: Jan. 28, 2010

(30) Foreign Application Priority Data
Jul. 10, 2009 (JP) 2009-164165

(51) Int. Cl. G06F 3/12; H04N 1/40; G06K 15/02

(52) U.S. Cl. 358/1.15; 358/448; 358/1.18

(57) ABSTRACT

A process determining apparatus includes: an instruction image acquiring unit that acquires an instruction image for instructing a process to be performed on a document image read from a medium having the document image formed thereon; and a determining unit that, when the instruction image acquired by the instruction image acquiring unit is not identified with any of a plurality of registered images to which processes are allocated, determines a process allocated to one of the plurality of registered images that is similar to the instruction image as the process to be performed on the document image read from the medium.

### CROSS-REFERENCE TO RELATED APPLICATIONS

This application is based on and claims priority under 35 USC 119 from Japanese Patent Application No. 2009-164165 filed Jul. 10, 2009.

### BACKGROUND

1. Technical Field

The present invention relates to a process determining apparatus, an image processing apparatus, a process determining system, a computer readable medium storing program, and a process determining method.

2. Related Art

### SUMMARY

According to an aspect of the invention, there is provided a process determining apparatus, including: an instruction image acquiring unit that acquires an instruction image for instructing a process to be performed on a document image read from a medium having the document image formed thereon; and a determining unit that, when the instruction image acquired by the instruction image acquiring unit is not identified with any of a plurality of registered images to which processes are allocated, determines a process allocated to one of the plurality of registered images that is similar to the instruction image as the process to be performed on the document image read from the medium.

### BRIEF DESCRIPTION OF THE DRAWINGS

Exemplary embodiments of the present invention will be described in detail based on the following figures, wherein:

FIG. 1 is a diagram illustrating the overall structure of a computer system according to an exemplary embodiment of the invention;

FIG. 2 is a block diagram illustrating an example of the hardware structure of a policy server according to the exemplary embodiment of the invention;

FIG. 3 is a block diagram illustrating an example of the functional structure of the policy server according to the exemplary embodiment of the invention;

FIG. 4 is a diagram illustrating an example of information in a stamp DB according to the exemplary embodiment of the invention;

FIG. 5 is a diagram illustrating an example of information in a policy DB according to the exemplary embodiment of the invention;

FIG. 6 is a diagram illustrating an example of information in a document information DB according to the exemplary embodiment of the invention;

FIG. 7 is a block diagram illustrating an example of the hardware structure of an image processing apparatus according to the exemplary embodiment of the invention;

FIG. 8 is a block diagram illustrating an example of the functional structure of the image processing apparatus according to the exemplary embodiment of the invention;

FIG. 9 is a block diagram illustrating an example of the functional structure of a terminal apparatus according to the exemplary embodiment of the invention;

FIGS. 10A and 10B are diagrams illustrating an example of a stamp registration sheet according to the exemplary embodiment of the invention;

FIG. 11 is a sequence diagram illustrating an example of the operation of the computer system according to the exemplary embodiment of the invention when a stamp is registered;

FIG. 12 is a diagram illustrating an example of a stamp registration screen according to the exemplary embodiment of the invention;

FIG. 13 is a diagram illustrating an example of a paper document having a stamp imprinted thereon used in the exemplary embodiment of the invention;

FIG. 14 is a sequence diagram illustrating an example of the operation of the computer system according to the exemplary embodiment of the invention when a document is registered;

FIG. 15 is a diagram illustrating an example of a policy selection screen according to the exemplary embodiment of the invention;

FIGS. 16A to 16F are diagrams illustrating an example of combinations of stamps that are determined to be similar to each other in the exemplary embodiment of the invention;

FIG. 17 is a sequence diagram illustrating an example of the operation of the computer system according to the exemplary embodiment of the invention when a document is read; and

FIG. 18 is a sequence diagram illustrating an example of the operation of the computer system according to the exemplary embodiment of the invention when a document is edited.

### DETAILED DESCRIPTION

Hereinafter, exemplary embodiments of the invention will be described in detail with reference to the accompanying drawings.

### Overall Structure of Computer System

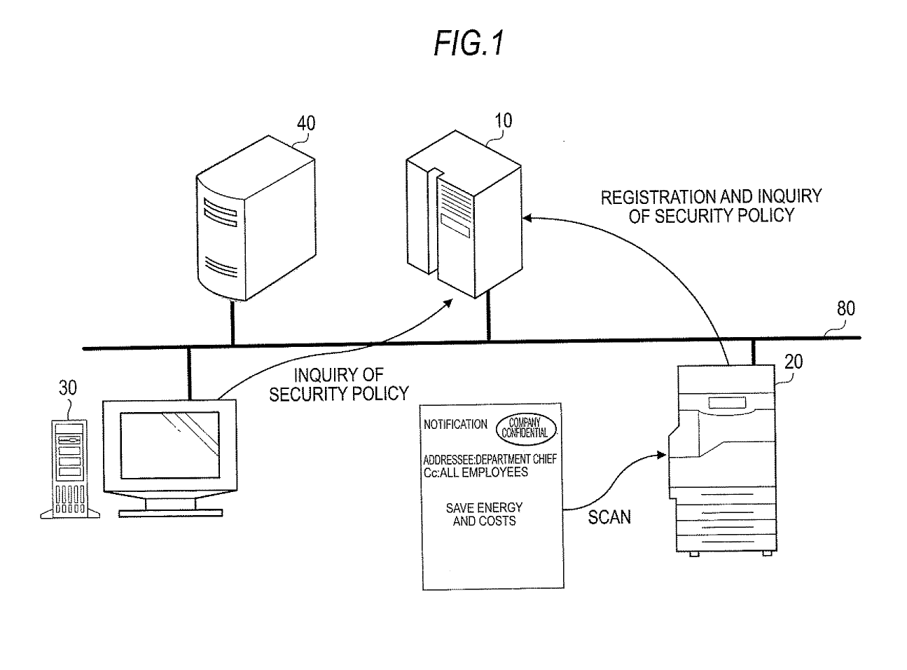

FIG. 1 is a diagram illustrating an example of the structure of a computer system according to an exemplary embodiment of the invention.

As shown in FIG. 1, the computer system includes a security policy server (hereinafter, referred to as a ‘policy server’) 10, an image processing apparatus 20, a terminal apparatus 30, and an authentication server 40 which are connected to a network 80.

The policy server 10 is a server computer that manages the security policy of a secure document. In the management of the security policy, specifically, a stamp is managed by a stamp database (hereinafter, referred to as a ‘stamp DB’), a security policy allocated to the stamp is managed by a security policy database (hereinafter, referred to as a ‘policy DB’), and a secure document having the security policy given thereto is managed by a document information database (hereinafter, referred to as a ‘document information DB’). For example, a computer such as a personal computer or a workstation, may be used as the policy server 10. In this exemplary embodiment, a process determining apparatus includes the policy server 10 as an example of a management apparatus.

The secure document means a document to which the security policy is given and whose operation is restricted. In addition, the secure document is associated with a specific security policy in the policy server 10, has a document ID for uniquely identifying the secure document, and is managed on the basis of the document ID. The secure document includes a header indicating a secure document, a document ID, and an encoded secure document body. Among them, the header is a predetermined byte string with a specific length. In this exemplary embodiment, it is assumed that the secure document is encoded by an encryption key that is common to all the secure documents, but this is just an example. The secure documents may be encoded by different encryption keys, as in a DRM (digital rights management) technique. In addition, in order to prevent the document ID of a certain secure document from being replaced with the document ID of another secure document, electronic signatures may be given to all the secure documents, or HMACs (keyed-hashing for message authentication codes) may be given to the secure documents. In both cases, in this system, all the secure documents are identified by identifiers, and there are no restrictions except that the security policies are given to the secure documents.

The security policy is information for defining access authority to the secure document. That is, the security policy is use regulation information for regulating the use of the secure document.

The image processing apparatus 20 reads the image of a paper document having a stamp imprinted thereon, extracts a stamp image from the read image, and communicates with the policy server 10 to perform a predetermined process. In addition, the image processing apparatus 20 performs an application to allow the user to register the stamp. In this exemplary embodiment, the image processing apparatus 20 is provided as an example of an image reading apparatus.

The terminal apparatus 30 communicates with the policy server 10 and performs a document processing application program (hereinafter, referred to as a ‘document process AP’) for reading or editing the secure document in the range that is permitted by the security policy. In this exemplary embodiment, for example, a computer such as a personal computer or a workstation may be used as the terminal apparatus 30.

The authentication server 40 is a server computer that manages user authentication, and executes processing upon receiving an inquiry from another apparatus required for user authentication. In this exemplary embodiment, for example, a computer such as a personal computer or a workstation may be used as the authentication server 40. In particular, an LDAP (lightweight directory access protocol) server or an active directory server may be used.

In this exemplary embodiment, the computer system shown in FIG. 1 is provided as an example of a process determining system including an image reading apparatus and a management apparatus.

### Structure of Policy Server

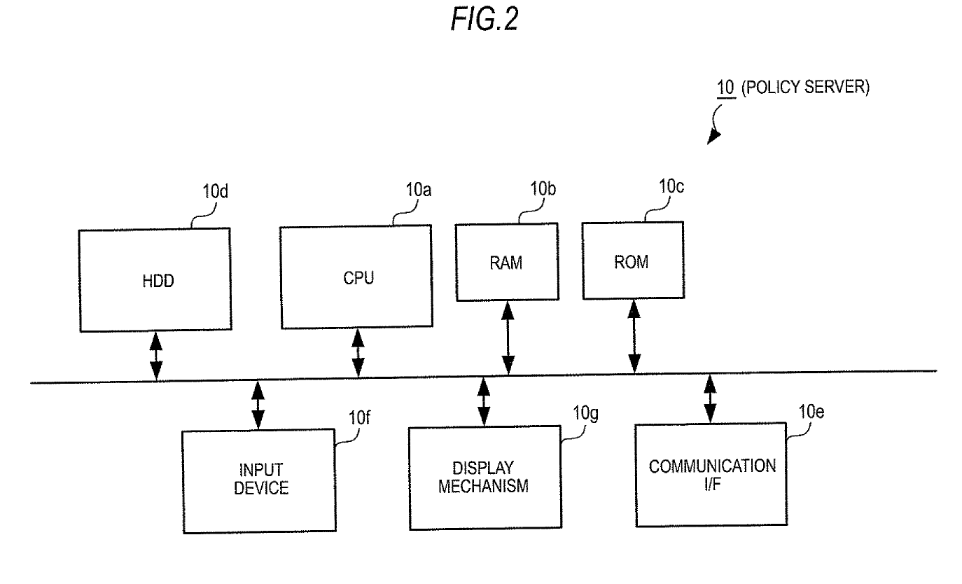

FIG. 2 is a diagram illustrating an example of the hardware structure of the policy server 10.

As shown in FIG. 2, the policy server 10 includes a CPU (central processing unit) 10a, a RAM (random access memory) 10b, a ROM (read only memory) 10c, an HDD (hard disk drive) 10d, a communication interface (hereinafter, referred to as a ‘communication I/F’) 10e, an input device 10f, and a display mechanism 10g.

The CPU 10a loads various kinds of programs stored in, for example, the ROM 10c to the RAM 10b and executes the programs to implement each function, which will be described below.

The RAM 10b is a memory that is used as, for example, a work memory of the CPU 10a.

The ROM 10c is a memory that stores, for example, various kinds of programs executed by the CPU 10a.

The HDD 10d is, for example, a magnetic disk device that stores input data to various kinds of programs executed by the CPU 10a or output data from various kinds of programs.

The communication I/F 10e transmits or receives various kinds of information to or from another apparatus through a communication unit.

The input device 10f is for inputting data and is, for example, a keyboard or a mouse.

The display mechanism 10g is for displaying information obtained when various kinds of programs are executed and includes, for example, a video memory or a display.

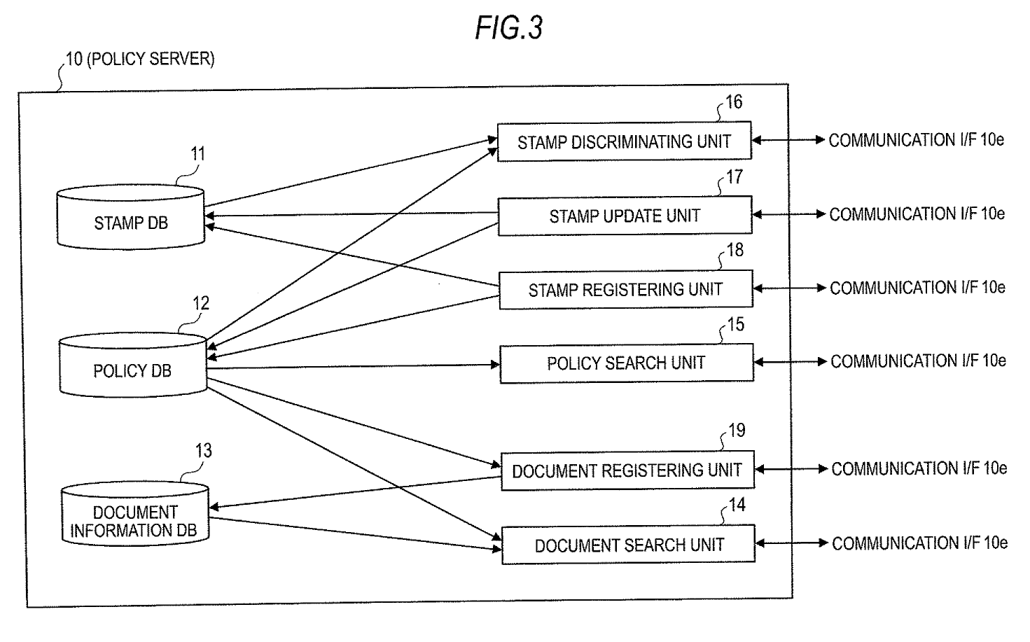

FIG. 3 is a diagram illustrating an example of the functional structure of the policy server 10.

As shown in FIG. 3, the policy server 10 includes a stamp DB 11, a policy DB 12, and a document information DB 13.

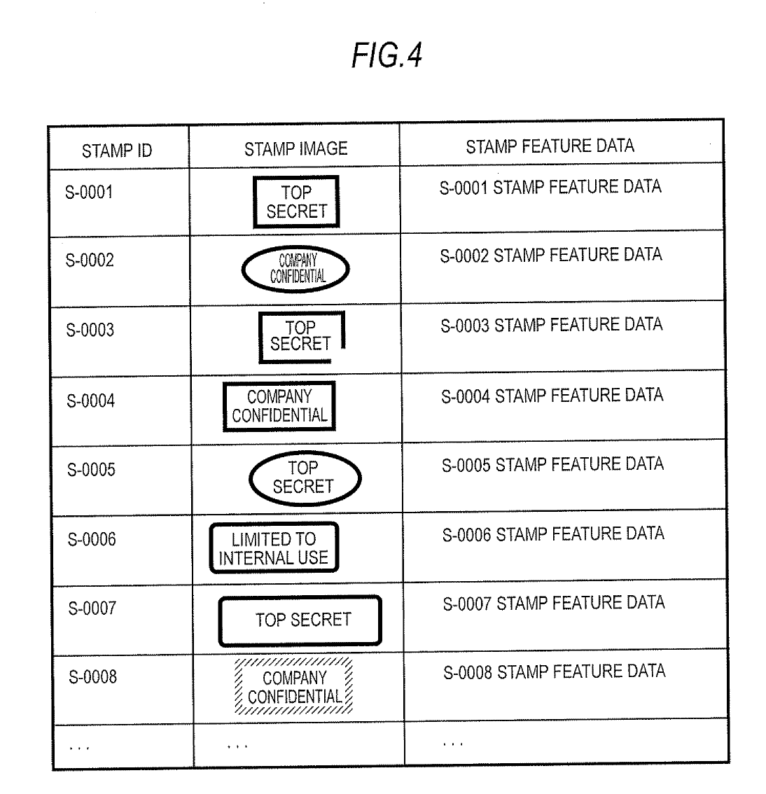

FIG. 4 is a diagram illustrating an example of the stamp information stored in the stamp DB 11.

As shown in FIG. 4, the stamp information includes a stamp ID, a stamp image, and stamp feature data. The stamp ID is information for uniquely identifying a stamp. The stamp image is image data of the stamp. The image data includes color information added thereto. In general, the stamp is imprinted with a bright-red stamping ink. Therefore, in FIG. 4, bright red is represented by gray. Meanwhile, black indicates a stamp imprinted with black ink. In a stamp image with a stamp ID ‘S-0008’, a frame is hatched, which indicates that the frame is blurred. The stamp feature data is feature data obtained by processing the stamp image. The feature data depends on algorithms, but any algorithm may be used.

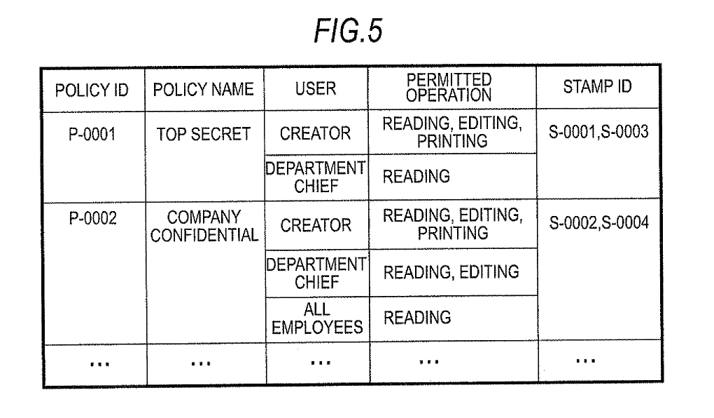

FIG. 5 is a diagram illustrating an example of the policy information stored in the policy DB 12.

As shown in FIG. 5, the policy information includes a policy ID, a policy name, a user, a permitted operation, and plural stamp IDs. The policy ID is information for uniquely identifying a security policy. The policy name is a name that is given to the security policy. The permitted operation is an operation that is permitted for each user or each group managed by the authentication server 40. The stamp ID is of a stamp to which a corresponding security policy is allocated. FIG. 5 shows an example in which plural stamp IDs is associated with one policy ID. However, one stamp ID may be associated with one policy ID.

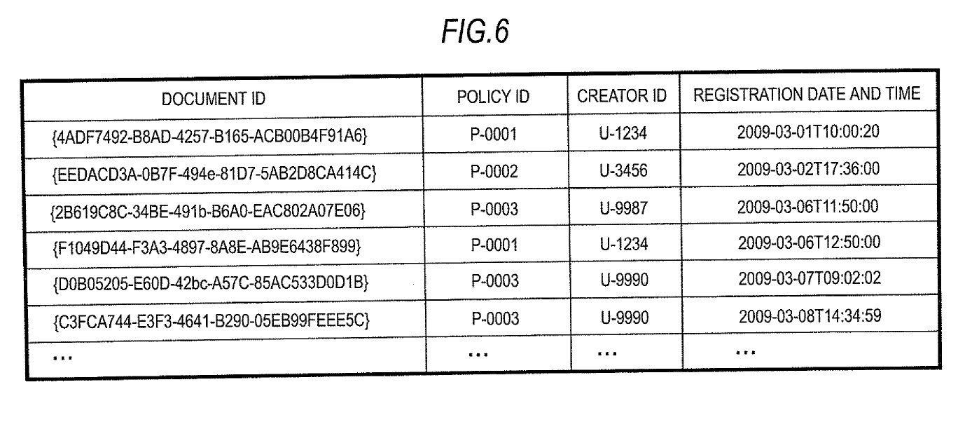

FIG. 6 is a diagram illustrating an example of the document information stored in the document information DB 13.

As shown in FIG. 6, the document information includes a document ID, a policy ID, a creator ID, and a registration date and time. The document ID is information for uniquely identifying the secure document. The policy ID is information for uniquely identifying the security policy given to the secure document. The creator ID is information for uniquely identifying a user (creator) who creates the secure document. The registration date and time indicates the date and time when the corresponding secure document is registered.

The policy DB 12 and the document information DB 13 may be constructed by the existing technique, but are not limited to the structures according to this exemplary embodiment. That is, any structure may be used as long as the security policy can be given to each secure document.

Referring to FIG. 3 again, the policy server 10 includes a document search unit 14, a policy search unit 15, a stamp discrimination unit 16, a stamp update unit 17, a stamp registering unit 18, and a document registering unit 19 as functional units that provide functions to an external apparatus. Next, these functional units will be described.

The document search unit 14 searches policy information from the secure document to which the security policy has already been set, in response to an inquiry from an external apparatus. In this case, the external apparatus designates the document ID of the secure document that the apparatus wants to query and the user ID of a user that the apparatus wants to query, and the document search unit 14 returns, for example, policy information.

The policy search unit 15 is called by the external apparatus that queries which policy can be given, searches for the policy information registered in the policy DB 12, and returns a list of security policies. The external apparatus may designate the user ID during the inquiry. In this case, the policy search unit may check whether there is a security policy that defines the operation authority of the user with the user ID.

The stamp discrimination unit 16 discriminates a stamp having the stamp image designated by the external apparatus from the stamp DB 11, in response to the inquiry from the external apparatus. Then, the stamp discrimination unit 16 extracts the policy ID of the security policy allocated to the discriminated stamp from the policy DB 12 and returns the extracted policy ID. In this exemplary embodiment, the stamp discrimination unit 16 is provided as an example of an instruction image acquiring unit that acquires an instruction image, a determining unit that determines the process allocated to a registered image which is similar to the instruction image as a process to be performed on a document image, and a presentation unit that presents the information of at least one process allocated to at least one registered image which is similar to the instruction image.

The stamp update unit 17 updates the stamp information of the stamp having the designated security policy allocated thereto. That is, when the external apparatus designates a policy ID and a stamp image and calls the stamp update unit 17, the stamp update unit 17 registers the stamp information in the stamp DB 11. Then, the stamp information is associated with the existing policy ID in the policy DB 12. In this case, in order to restrict the user who can update the stamp information, the system may be constructed such that user authentication is performed at the beginning and only a predetermined user can update the stamp information. In this exemplary embodiment, the stamp update unit 17 is provided as an example of a registering unit that allocates the instruction image to the process allocated to a registered image similar to the instruction image and registers it.

The stamp registering unit 18 registers the stamp information of the discriminated stamp in the stamp DB 11. That is, when the external apparatus designates a policy ID and a stamp image and calls the stamp registering unit 18, the stamp registering unit 18 registers the stamp information in the stamp DB 11 so as to be associated with the designated policy ID in the policy DB 12. In this case, in order to restrict the user who can register the stamp, the system may be constructed such that user authentication is performed at the beginning and only a predetermined user can register the stamp. In addition, plural stamp images may be designated, and the above-mentioned process may be performed on all of the stamp images.

The document registering unit 19 registers document information that defines the protection of a document by the designated security policy. That is, when the external apparatus designates a user ID and a policy ID and calls the document registering unit 19, the document registering unit registers document information obtained by adding a document ID and a process time to the information in the document information DB 13.

### Structure of Image Processing Apparatus

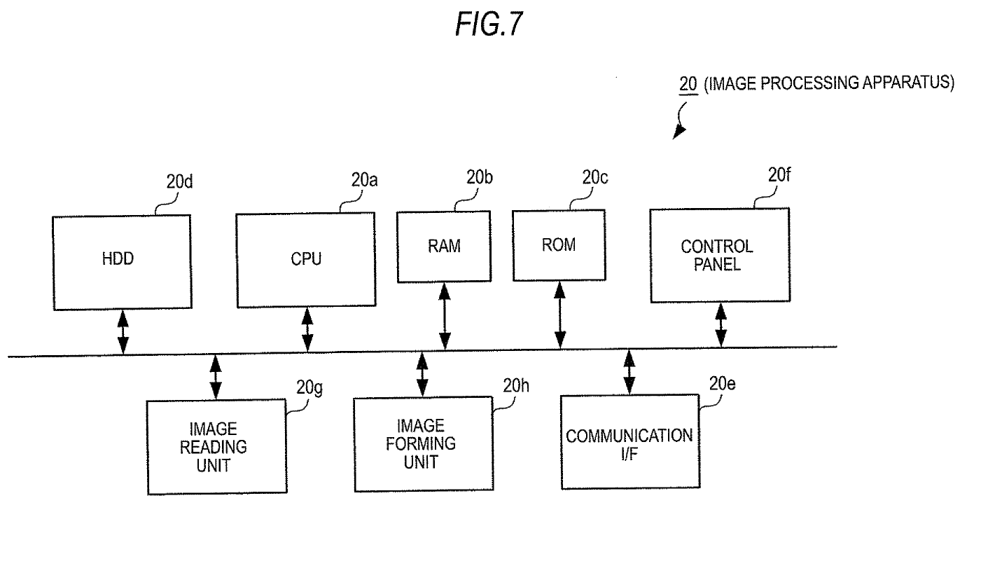

FIG. 7 is a diagram illustrating an example of the hardware structure of the image processing apparatus 20.

As shown in FIG. 7, the image processing apparatus 20 includes a CPU (central processing unit) 20a, a RAM (random access memory) 20b, a ROM (read only memory) 20c, an HDD (hard disk drive) 20d, a communication interface (hereinafter, referred to as a ‘communication I/F’) 20e, a control panel 20f, an image reading unit 20g, and an image forming unit 20h.

The CPU 20a loads various kinds of programs stored in, for example, the ROM 20c to the RAM 20b and executes the programs to implement each function, which will be described below.

The RAM 20b is a memory that is used as, for example, a work memory of the CPU 20a.

The ROM 20c is a memory that stores, for example, various kinds of programs executed by the CPU 20a.

The HDD 20d is, for example, a magnetic disk device that stores image data read by the image reading unit 20g or image data used for the image forming unit 20h to form an image.

The communication I/F 20e transmits or receives various kinds of information to or from another apparatus through a communication unit.

The control panel 20f is, for example, a touch panel that displays various kinds of information or receives an operation input from the user. In this exemplary embodiment, the control panel 20f is provided as an example of a display unit that displays the information of at least one process allocated to at least one registered image that is similar to the instruction image.

The image reading unit 20g reads an image recorded on a recording medium such as a sheet. The image reading unit 20g is, for example, a scanner, and may be a CCD type in which a light source emits light to a document, light reflected from the document is reduced by a lens, and a CCD (charge couple device) receives the light, or a CIS type in which an LED light source emits light to a document and a CIS (contact image sensor) receives light reflected from the document. In this exemplary embodiment, the image reading unit 20g is provided as an example of a read unit that reads an image from a medium.

The image forming unit 20h forms an image on a recording medium such as a sheet. The image forming unit 20h is, for example, a printer and may be an electrophotographic type that transfers toner adhered to a photoconductor onto a recording medium to form an image or an inkjet type that discharges ink onto a recording medium to form an image.

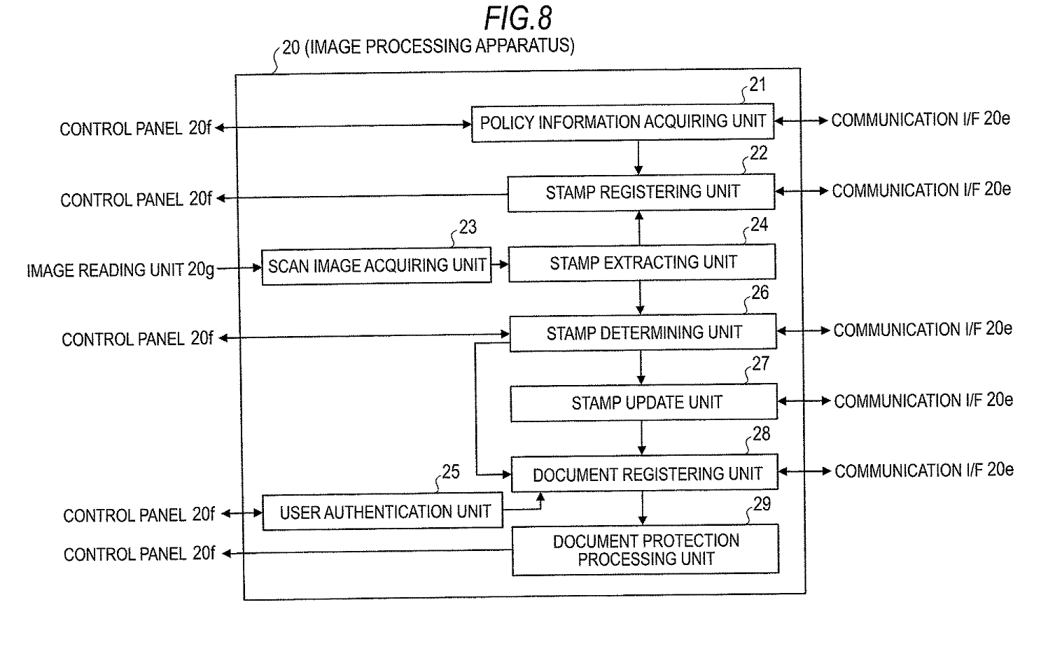

FIG. 8 is a diagram illustrating an example of the functional structure of the image processing apparatus 20.

As shown in FIG. 8, the image processing apparatus 20 includes a policy information acquiring unit 21, a stamp registering unit 22, a scan image acquiring unit 23, a stamp extracting unit 24, a user authentication unit 25, a stamp discrimination unit 26, a stamp update unit 27, a document registering unit 28, and a document protection processing unit 29. Next, these functional units will be described. The registration of stamps and documents will be described in detail below.

The policy information acquiring unit 21 is operated when the stamp is registered, and calls the policy search unit 15 of the policy server 10 in response to a request to display a policy information list (hereinafter, referred to as a ‘policy list’) related to the current security policy from the control panel 20f. Then, the policy information acquiring unit 21 acquires the policy list, displays the policy list on the control panel 20f, and acquires the policy ID selected from the policy list.

The stamp registering unit 22 is operated when the stamp is registered, designates the policy ID transmitted from the policy information acquiring unit 21 and the stamp image transmitted from the stamp extracting unit 24, which will be described below, and calls the stamp registering unit 18 of the policy server 10. In this way, the stamp image is registered in the policy server 10 so as to be associated with the policy ID.

The scan image acquiring unit 23 is operated when the stamp and the document are registered, and acquires a scan image read by the image reading unit 20g. In this exemplary embodiment, the scan image acquiring unit 23 is provided as an example of a document image acquiring unit that acquires a document image.

The stamp extracting unit 24 is operated when the stamp and the document are registered, extracts a stamp image from the scan image acquired by the scan image acquiring unit 23, and transmits the extracted stamp image to the stamp registering unit 22. For example, the stamp maybe extracted by the existing method of cutting out a portion having a specific shape from the scan image. In this exemplary embodiment, the stamp extracting unit 24 is provided as an example of an acquiring unit that acquires the instruction image.

The user authentication unit 25 communicates with the authentication server 40 and performs user authentication on the basis of, for example, a user ID and a password input from the control panel 20f. When the user authentication succeeds, the user authentication unit 25 stores the user ID and transmits it to the document registering unit 28.

The stamp discrimination unit 26 designates the stamp image transmitted from the stamp extracting unit 24 and calls the stamp discrimination unit 16 of the policy server 10. When the policy ID is acquired, the stamp discrimination unit 26 transmits the policy ID to the document registering unit 28. When a list of policy IDs is acquired, the stamp discrimination unit 26 displays the list on the control panel 20f and transmits the policy ID selected from the list to the document registering unit 28. The stamp discrimination unit 26 transmits the policy ID and the stamp image to the stamp update unit 27, if the user wants it. In this exemplary embodiment, the stamp discrimination unit 26 is provided as a determining unit that determines the process selected by the operator as a process to be performed on the document image.

The stamp update unit 27 designates the policy ID and the stamp image transmitted from the stamp discrimination unit 26 and calls the stamp update unit 17 of the policy server 10. In this way, the stamp image is additionally registered in the policy server 10 so as to be associated with the policy ID.

The document registering unit 28 designates the user ID transmitted from the user authentication unit 25 and the policy ID transmitted from the stamp discrimination unit 26 and calls the document registering unit 19 of the policy server 10. Then, the document registering unit 28 acquires the document ID of document data generated from the scan image and transmits it to the document protection processing unit 29. In this exemplary embodiment, the document registering unit 28 is provided as an example of a processing unit that performs the process determined with respect to the document image.

The document protection processing unit 29 gives a document ID to the document data generated from the scan image, encodes a document data body to generate a secure document, and stores the secure document.

### Structure of Terminal Apparatus

The hardware structure of the terminal apparatus 30 is the same as that shown in FIG. 2. However, the CPU 10a, the RAM 10b, the ROM 10c, the HDD 10d, the communication I/F 10e, the input device 10f, and the display mechanism 10g are respectively referred to as a CPU 30a, a RAM 30b, a ROM 30c, an HDD 30d, a communication I/F 30e, an input device 30f, and a display mechanism 30g.

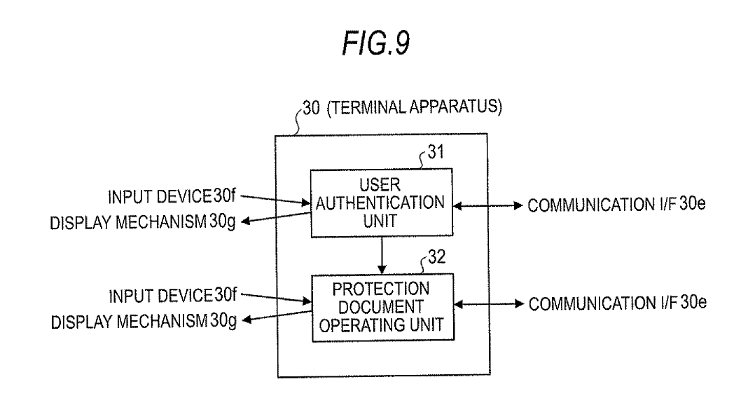

FIG. 9 is a diagram illustrating an example of the functional structure of the terminal apparatus 30.

As shown in FIG. 9, the terminal apparatus 30 includes a user authentication unit 31 and a secure document operating unit 32. The terminal apparatus 30 used by the general user performs the document process AP that edits or prints the secure document in the range permitted by the security policy, and the document process AP is performed to implement these functional units. Next, these functional units will be described.

The user authentication unit 31 communicates the authentication server 40 to perform user authentication on the basis of the user ID and the password input from the input device 30f. If the user authentication succeeds, the user authentication unit 31 stores the user ID and transmits it to the secure document operating unit 32.

The secure document operating unit 32 communicates with the policy server 10 to perform a secure document operating process, such as, reading, editing, or printing, in response to a request input from the input device 30f.

### Structure of Authentication Server

The hardware structure of the authentication server 40 is the same as that shown in FIG. 2. However, the CPU 10a, the RAM 10b, the ROM 10c, the HDD 10d, the communication I/F 10e, the input device 10f, and the display mechanism 10g are respectively referred to as a CPU 40a, a RAM 40b, a ROM 40c, an HDD 40d, a communication I/F 40e, an input device 40f, and a display mechanism 40g.

Although not shown in the drawings, the functional structure of the authentication server 40 may include at least a database that manages the correspondence between user IDs and passwords and a function of returning authentication success when the correspondence between the user ID and the password received from an external apparatus is managed by the database and returning authentication failure when the correspondence is not managed by the database.

### Operation of This Exemplary Embodiment

Next, the operation of this exemplary embodiment will be described.

The operations of this exemplary embodiment include a process of allocating a stamp to a security policy and registering it using the process image processing apparatus 20 (hereinafter, referred to as a ‘stamp registering process’), a process of giving a secure document to a security policy and registering it using the image processing apparatus 20 (hereinafter, referred to as a ‘document registering process’), and a process of operating a secure document in the range permitted by the security policy using the terminal apparatus (hereinafter, referred to as a ‘document operating process’). Next, these operations will be separately described.

### Stamp Registering Process

First, the user places a stamp registration sheet having a stamp imprinted thereon which the user wants to register on a platen of the image processing apparatus 20 and starts up a stamp registering function.

Next, the stamp registration sheet will be described.

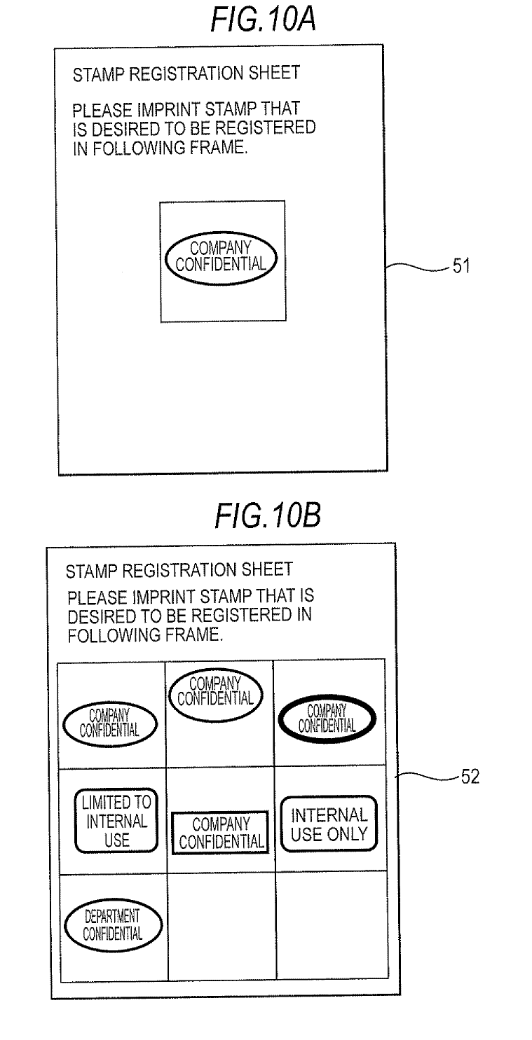

FIGS. 10A and 10B show an example of the stamp registration sheet.

FIG. 10A shows a stamp registration sheet 51 for registering one stamp at a time. As shown in FIG. 10B, a stamp registration sheet 52 capable of registering plural stamps at a time may be used. Even when plural stamps is imprinted on one stamp registration sheet, one security policy may be allocated. In this case, the same security policy is allocated to all the stamp images. When the same stamp is repeatedly imprinted on one stamp registration sheet plural times, for example, variation of manner to imprint the stamp may be absorbed. When plural different stamps are imprinted on one stamp registration sheet, documents having different stamps imprinted thereon may be protected by the same security policy.

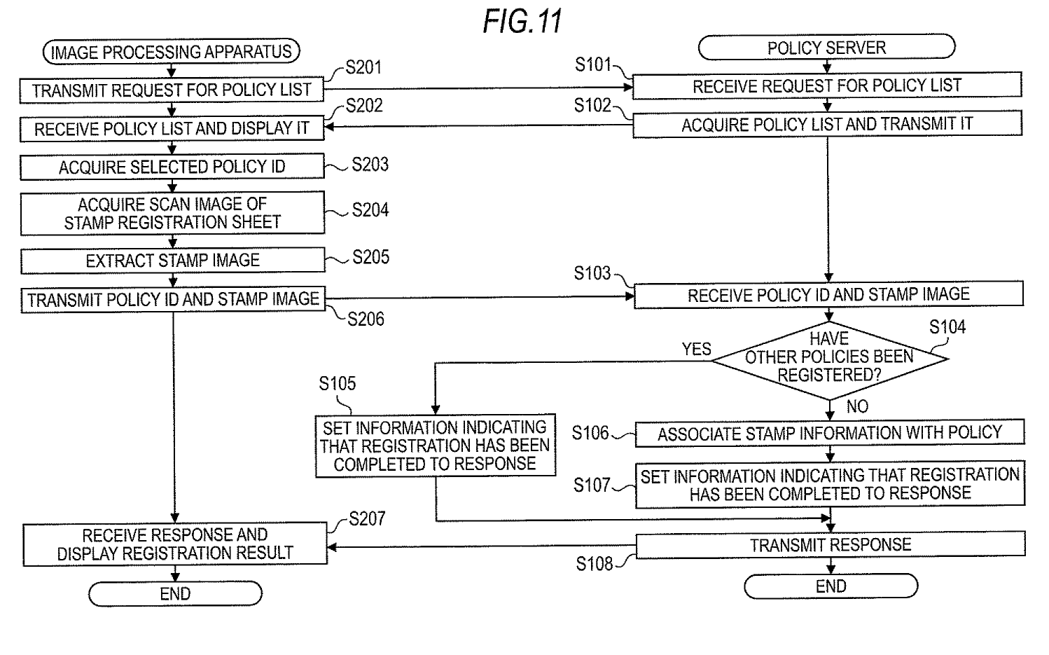

FIG. 11 is a sequence diagram illustrating information exchange between the image processing apparatus 20 and the policy server 10 when the stamp registering function starts up.

In the image processing apparatus 20, when the stamp registering function starts up, the policy information acquiring unit 21 calls the policy search unit 15 of the policy server 10 and transmits a request for a policy list (Step 201).

Then, in the policy server 10, the policy search unit 15 receives the request for the policy list (Step 101). Then, the policy search unit 15 searches the policy DB 12, acquires the security policy registered in the policy DB 12, and returns the acquired security policy as the policy list to the image processing apparatus 20 (Step 102).

Then, in the image processing apparatus 20, the policy information acquiring unit 21 receives the policy list and displays a stamp registration screen 280 on the control panel 20f (Step 202).

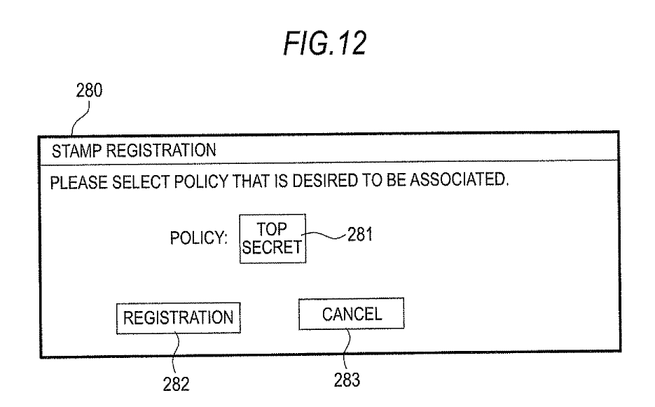

FIG. 12 shows an example of the stamp registration screen 280. On the stamp registration screen 280, the user selects the security policy to allocate to the stamp. Here, a security policy named ‘top secret’ is selected, and is displayed in a box 281. That is, the previously acquired policy list is displayed as a drop-down list, and when the user selects ‘top secret’ from the list, ‘top secret’ is displayed in the box 281.

In this state, when the user presses a ‘registration’ button 282, the policy information acquiring unit 21 acquires the policy ID of the selected security policy, and transmits the policy ID to the stamp registering unit 22 (Step 203). The stamp registration sheet having the stamp imprinted thereon is scanned by the image reading unit 20g, and the scan image acquiring unit 23 acquires a scan image obtained by scanning and transmits the scan image to the stamp extracting unit 24 (Step 204). The stamp extracting unit 24 searches for a place where the stamp is imprinted from the scan image, generates a stamp image, and transmits the stamp image to the stamp registering unit 22 (Step 205).

Then, the stamp registering unit 22 designates the policy ID transmitted in Step 203 and the stamp image transmitted in Step 205, and calls the stamp registering unit 18 of the policy server 10 (Step 206).

Then, in the policy server 10, the stamp registering unit 18 receives the policy ID and the stamp image (Step 103).

Then, the stamp registering unit 18 determines whether the designated stamp image is allocated with a policy ID other than the designated policy ID and is registered (Step 104). Specifically, first, the stamp registering unit 18 calculates stamp feature data of the designated stamp image. Then, the stamp registering unit 18 searches for a record of the designated policy ID from the policy DB 12. Then, the stamp registering unit 18 determines whether a stamp of stamp feature data that is identical to the calculated stamp feature data, among the stamps other than the stamp with the stamp ID defined by the record, is registered in the stamp DB 11.

As a result, if it is determined that the stamp has already been registered, the stamp registering unit 18 sets an error indicating that ‘a target stamp has already been registered’ as a response (Step 105).

On the other hand, if it is determined that the stamp has not been registered, the stamp registering unit 18 registers stamp information related to the designated stamp so as to be associated with the designated policy ID (Step 106). Specifically, first, the stamp registering unit 18 calculates stamp feature data from the designated stamp image. Then, the stamp registering unit 18 registers a newly generated stamp ID, the designated stamp image, and the calculated stamp feature data in the stamp DB 11. Then, the stamp registering unit 18 adds the newly generated stamp ID as the stamp ID of the record of the designated policy ID.

Then, the stamp registering unit 18 sets a response indicating that the security policy has been allocated to the stamp image (Step 107).

Subsequently, the stamp registering unit 18 sends back the response to the image processing apparatus 20 (Step 108).

Then, in the image processing apparatus 20, the stamp registering unit 22 receives the result of the stamp registering process and displays it on the control panel 20f (Step 207). However, when the user presses a ‘cancel’ button 283 with the stamp registration screen 280 shown in FIG. 12 being displayed, the process ends.

### Document Registering Process

First, the user places a paper document having a stamp imprinted thereon on the platen of the image processing apparatus 20, and starts up the document registering function.

Next, the paper document having a stamp imprinted thereon will be described.

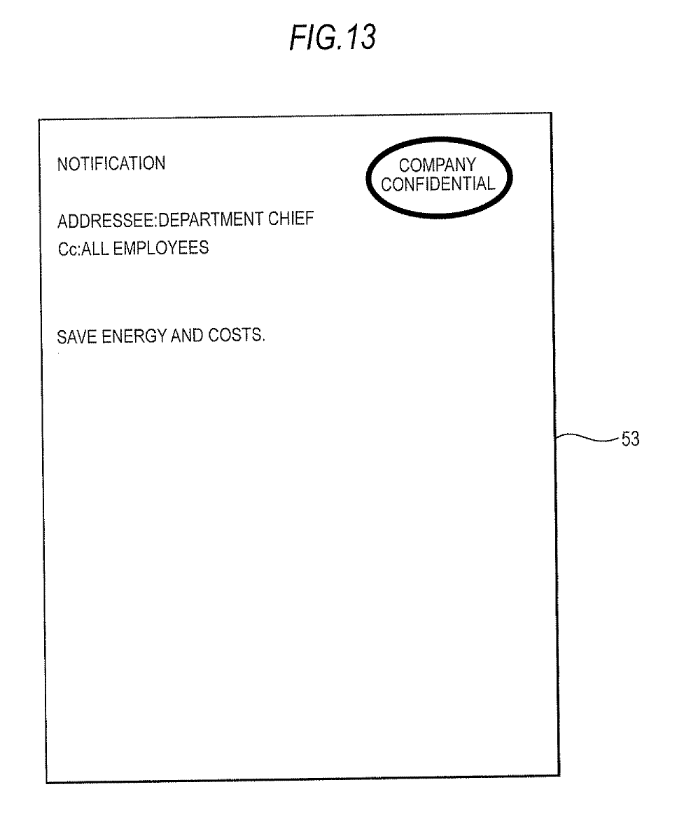

FIG. 13 is a diagram illustrating a paper document 53 having a stamp imprinted thereon.

A document image titled a ‘notification’ is printed on the entire paper document, and a stamp ‘company confidential’ is imprinted on an upper right side of the paper document.

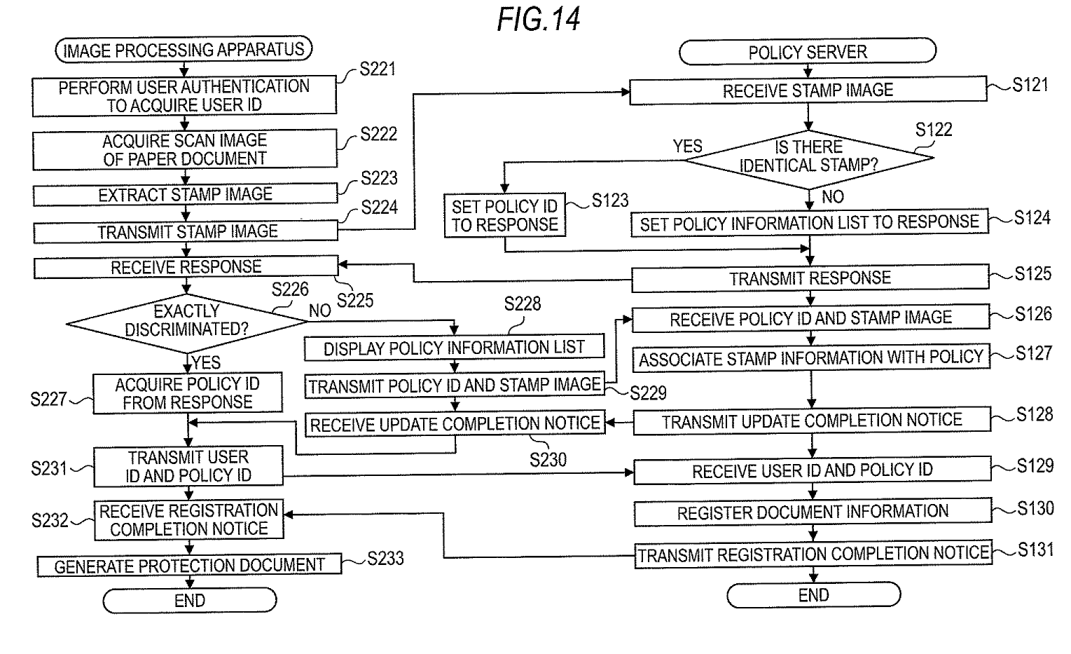

FIG. 14 is a sequence diagram illustrating information exchange between the image processing apparatus 20 and the policy server 10 when the document registering function starts up.

In the image processing apparatus 20, when the document registering function starts up, first, the user authentication unit 25 performs user authentication. If the user authentication succeeds, the user authentication unit 25 stores the user ID (Step 221). Specifically, the user authentication unit 25 prompts the user to input the user ID and the password, and queries the authentication server 40 to check whether a combination of the user ID and the password is correct. If the user authentication succeeds, the user authentication unit 25 transmits the user ID to the document registering unit 28. If the user authentication fails, the process is interrupted (not shown).

Then, the paper document having the stamp imprinted thereon is scanned by the image reading unit 20g, and the scan image acquiring unit 23 acquires a scan image obtained by scanning and transmits the scan image to the stamp extracting unit 24 (Step 222). The stamp extracting unit 24 searches for a place where the stamp is imprinted from the scan image, generates a stamp image, and transmits the stamp image to the stamp discrimination unit 26 (Step 223). However, in this case, the scan image from which the stamp image is extracted is stored as electronic document data in the memory once.

Then, the stamp discrimination unit 26 designates the transmitted stamp image and calls the stamp discrimination unit 16 of the policy server 10 (Step 224).

Then, in the policy server 10, the stamp discrimination unit 16 receives the designated stamp image (Step 121).

Then, the stamp discrimination unit 16 determines whether the stamp with a stamp image that is identical to the designated stamp image is registered (Step 122). Specifically, first, the stamp discrimination unit 16 calculates stamp feature data of the designated stamp image. Then, the stamp discrimination unit 16 determines whether the stamp with stamp feature data that is identical to the stamp feature data is registered with reference to the stamp DB 11. However, it is difficult for the stamp feature data items to be completely identical to each other due to image blur occurring in the actual stamp image. Therefore, here, it is determined that the stamp feature data of the registered stamp image is ‘identical’ to the stamp feature data of the designated stamp image when the difference therebetween is equal to or less than a first threshold value, which is a very small value.

As a result, if it is determined that the identical stamp is registered, the stamp discrimination unit 16 searches for a policy ID corresponding to the registered stamp ID from the policy DB 12 and sets the policy ID to a response (Step 123).

On the other hand, if it is determined that the identical stamp is not registered, the stamp discrimination unit 16 selects a stamp with stamp feature data similar to the stamp feature data of the designated stamp image from the registered stamps, and sets a list of policy information (policy information list) corresponding to the stamp ID of the selected stamp to the response (Step 124). Here, it may be determined that the stamp feature data of the registered stamp image is ‘similar’ to the stamp feature data of the designated stamp image when the difference therebetween is equal to or less than a second threshold value that is greater than the first threshold value. The policy information set to the response may include at least the policy ID and a policy name. The policy information may also include information indicating that ‘there is no identical stamp and a list of security policies allocated to similar stamps is selected’ or the stamp images of similar stamps, in addition to the policy ID and the policy name.

Thereafter, the stamp discrimination unit 16 sends back the response to the image processing apparatus 20 (Step 125).

Then, in the image processing apparatus 20, the stamp discrimination unit 26 receives the response from the policy server 10 (Step 225).

Then, the stamp discrimination unit 26 determines whether the content of the response indicates that the policy server 10 can correctly determine the stamp (Step 226). Specifically, the stamp discrimination unit 26 determines whether the policy ID is set to the response or the policy information list is set to the response.

As a result, if it is determined that the content of the response indicates that the policy server 10 can correctly determine the stamp, that is, if it is determined that the policy ID is set to the response, the stamp discrimination unit 26 extracts the policy ID from the response and transmits it to the document registering unit 28 (Step 227).

On the other hand, if it is determined that the content of the response indicates that the policy server 10 cannot correctly determine the stamp, that is, if it is determined that the policy information list is set to the response, the stamp discrimination unit 26 acquires the policy information list from the response and displays a stamp selection screen 290 on the control panel 20f (Step 228).

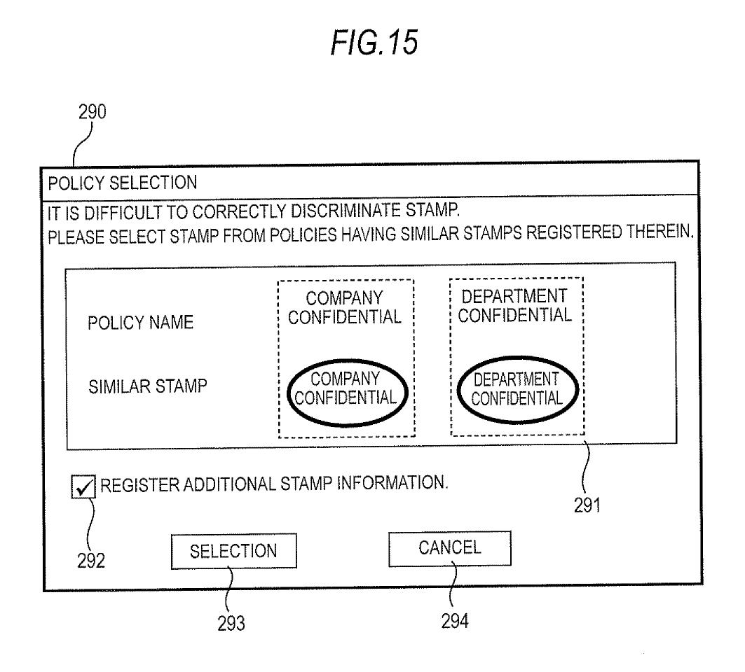

FIG. 15 shows an example of the stamp selection screen 290. The stamp selection screen 290 includes a list 291 of sets of policy names and similar stamps. That is, it is assumed that the stamp images of similar stamps are transmitted from the policy server 10 in addition to the policy ID and the policy name. The user selects a set of security policies that the user wants to apply to electronic document data from the list 291. When the user also wants to register the stamp image extracted from the current scan image, the user checks a check box 292 indicating that ‘stamp information is additionally registered’.

In this state, when the user presses a ‘selection’ button 293, the stamp discrimination unit 26 transmits the policy ID included in the set that is selected by the user to the document registering unit 28. In addition, the stamp discrimination unit 26 transmits the policy ID and the stamp image acquired in Step 223 to the stamp update unit 27.

The stamp update unit 27 designates the policy ID and the stamp image and calls the stamp update unit 17 of the policy server 10 (Step 229).

Then, in the policy server 10, the stamp update unit 17 receives the designated policy ID and stamp image (Step 126). Then, the stamp update unit 17 registers stamp information related to the designated stamp so as to be associated with the designated policy ID (Step 127). Specifically, first, the stamp update unit 17 calculates stamp feature data from the designated stamp image. Then, the stamp update unit 17 registers a newly generated stamp ID, the designated stamp image, and the calculated stamp feature data in the stamp DB 11. Then, the stamp update unit 17 adds the newly generated stamp ID as the stamp ID of the record of the designated policy ID.

Thereafter, the stamp update unit 17 transmits an update completion notice indicating that the stamp image has been completely updated (Step 128).

Then, in the image processing apparatus 20, the stamp update unit 27 receives the update completion notice (Step 230). However, when the user presses a ‘cancel’ button 294 with the stamp selection screen 290 shown in FIG. 15 being displayed, the process ends. When the user presses the ‘selection’ button 293 without checking the check box 292, the process proceeds to Step 231 without performing Steps 229 and 230.

Then, the document registering unit 28 designates the user ID transmitted in Step 221 and the policy ID transmitted in Step 227 or Step 229, and calls the document registering unit 19 of the policy server 10 (Step 231).

Then, in the policy server 10, the document registering unit 19 receives the designated user ID and policy ID (Step 129). Thereafter, the document registering unit 19 searches for the security policy of the designated policy ID from the policy DB 12, and registers the document information of document data generated by the current scanning operation in the document information DB 13 (Step 130). Specifically, the document registering unit 19 registers a newly generated document ID, the policy. ID, the user ID, and a process time in the document information DB 13. In this case, the user ID is registered as a creator ID and the process time is registered as a registration date and time in the document information DB 13.

Then, the document registering unit 19 transmits a registration completion notice including the document ID to the image processing apparatus 20 (Step 131).

Then, in the image processing apparatus 20, the document registering unit 28 receives the registration completion notice, designates the document ID, and calls the document protection processing unit 29 (Step 232).

The document protection processing unit 29 encodes the body of the document data temporarily stored in the memory in Step 223 and inserts the document ID into the document data to generate a secure document (Step 233). The secure document is accumulated in, for example, a confidential box of the image processing apparatus 20 such that the user can acquire the secure document later. The generation result of the secure document is displayed on the control panel 20f.

Next, the determination of the similarity of the stamp in Step 124 will be described in detail.

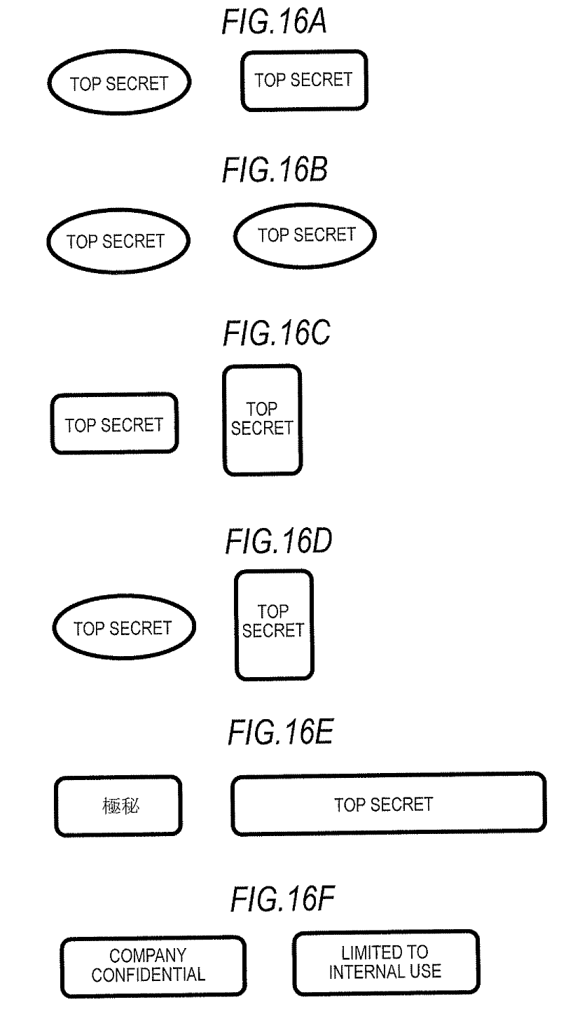

FIGS. 16A to 16F show an example in which the stamps are determined to be similar to each other. In this case, similar to FIG. 4, the stamp imprinted with a bright red stamping ink is represented in gray, and the stamp imprinted with a black stamping ink is represented in black.

FIG. 16A shows an example in which the stamps are different from each other in the shape of the frame.

In this case, the frame may be removed by image processing and it may be determined whether the internal images are equal to each other. When there are character strings in the frames, the character strings may be converted into text data by an OCR (optical character recognition) process, and it may be determined that the text data is identical to each other. In this way, for example, the difference between the font types of the characters is absorbed.

FIG. 16B shows an example in which the stamps are different from each other in color. In FIG. 16B, a left stamp is bright red and a right stamp is black.

In this case, color information may be removed by image processing and it may be determined whether the images are identical to each other.

FIG. 16C shows an example in which the stamps are different from each other only in that there is line break or not.

In this case, similar to FIG. 16A, after the frames are removed, the character strings may be converted into text data by the OCR process, and it may be determined whether the text data are identical to each other.

FIG. 16D shows an example in which the stamps are different from each other in that there is line break or not and in the shape of the frame.

In this case, similar to FIGS. 16A and 16C, after the frames are removed, the character strings may be converted into text data by the OCR process, and it may be determined whether the text data are identical to each other.

FIG. 16E shows an example in which the stamps are different from each other in the language of the characters. FIG. 16E shows a stamp including a Japanese character string ‘GOKUHI’ and a stamp including an English character string ‘TOP SECRET’.

In this case, a correspondence table between Japanese words (character strings) and English words (character strings) is prepared. Then, the words may be converted into text data by the OCR process, and it may be determined whether the text data are identical to each other with reference to the correspondence table. However, for more general purposes, that is, in order to correspond between various kinds of similar languages without specially registering words (character strings), a general-purpose dictionary (for example, an English-Japanese dictionary/a Japanese-English dictionary), not the correspondence table, may be used.

FIG. 16F shows an example in which the stamps have the same meaning, but are represented by different words. FIG. 16F shows a stamp including a character string ‘company confidential’ and a stamp including a character string ‘limited to internal use’. These stamps include different character strings, but have the same meaning.

In this case, after the character strings are converted into text data by the OCR process, the text data is searched from the correspondence table or a synonym dictionary, and it is determined whether the data are identical to each other.

Although not shown in the drawings, it is determined that the stamp which is partially blurred is similar to the stamp that is not blurred.

In this case, image processing is performed on the stamp that is imprinted on the scanned paper document and is partially blurred to determine which part of the stamp is blurred, and the same part of the stamp image, which is a comparison target, stored in the policy server 10 as that of the stamp is cut out in the same shape. Then, the stamp feature data thereof is calculated and compared.

### Document Operating Process

The following various operations are considered for the secure document: reading, editing, storage, printing, macro execution, search, and text copy. Here, reading and editing will be described as a representative example. Other operations may be similarly performed as long as the operations are permitted in the policy DB 12.

First, the reading of the secure document will be described.

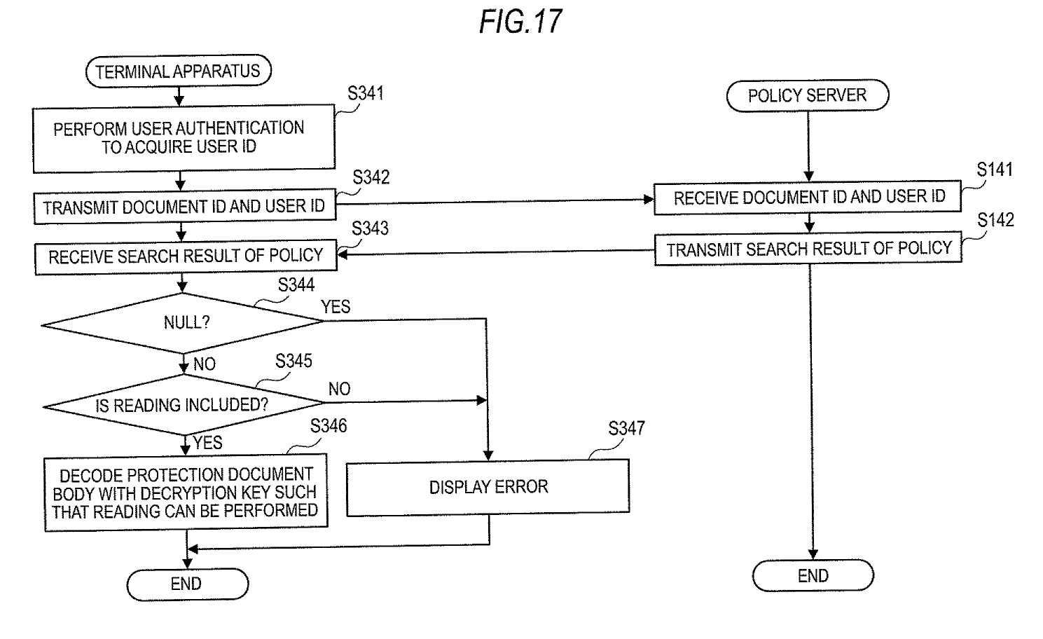

FIG. 17 is a sequence diagram illustrating information exchange between the terminal apparatus 30 and the policy server 10 when the user reads the secure document. This sequence starts up when the user designates a secure document and starts up the document process AP.

When the document process AP starts up, in the terminal apparatus 30, first, the user authentication unit 31 performs user authentication. If the user authentication succeeds, the user authentication unit 31 stores the user ID (Step 341). Specifically, the user authentication unit 31 prompts the user to input the user ID and the password, and queries the authentication server 40 to check whether a combination of the user ID and the password is correct. If the user authentication succeeds, the user authentication unit 31 transmits the user ID to the secure document operating unit 32. If the user authentication fails, the process is interrupted (not shown).

Then, the secure document operating unit 32 acquires the secure document, reads the document ID from the acquired secure document, acquires the user ID from the user authentication unit 31, and calls the document search unit 14 of the policy server 10 using the document ID and the user ID as parameters (Step 342).

Then, in the policy server 10, the document search unit 14 receives the document ID and the user ID (Step 141).

Then, the document search unit 14 searches for a record of the designated document ID from the document information DB 13, and sends back the search result to the terminal apparatus 30 (Step 142). Specifically, the document search unit 14 searches for the record of the designated document ID from the document information DB 13 and acquires the policy ID included in the record. Then, the document search unit 14 searches for a record of the policy ID from the policy DE 12, and extracts an operation permitted to the designated user, among the operations permitted to each user. In this case, it is determined whether the designated user ID is identical to the creator ID of a target secure document for an entry in which the user is a ‘creator’. If it is determined that the designated user ID is identical to the creator ID, the permitted operation in the entry is also extracted. When the permitted operation is extracted, the extracted result is sent back. When the permitted operation is not extracted, NULL is sent back.

Then, in the terminal apparatus 30, the secure document operating unit 32 receives the search result from the policy server 10 (Step 343) and determines whether the search result is NULL (Step 344).

As a result, if it is determined that the search result is NULL, the secure document operating unit 32 displays, for example, an error message indicating that ‘there is no access authority to the designated document’ on the display mechanism 30g since the operation of the designated secure document is not permitted (Step 347). Then, the process ends.

On the other hand, if it is determined that the search result is not NULL, the secure document operating unit 32 determines whether ‘reading’ is included with reference to the permitted operation items included in the search result (Step 345). If it is determined that ‘reading’ is not included, the secure document operating unit 32 displays an error indicating that ‘there is no authority to read the designated document’ (Step 347), and the process ends. If it is determined that ‘reading’ is included, it is determined that there is authority to read the designated document. Therefore, the secure document operating unit 32 decodes the document body with a predetermined decryption key and displays the document on the display mechanism 30g such that the user can read the document (Step 346).

Next, the editing of the secure document will be described.

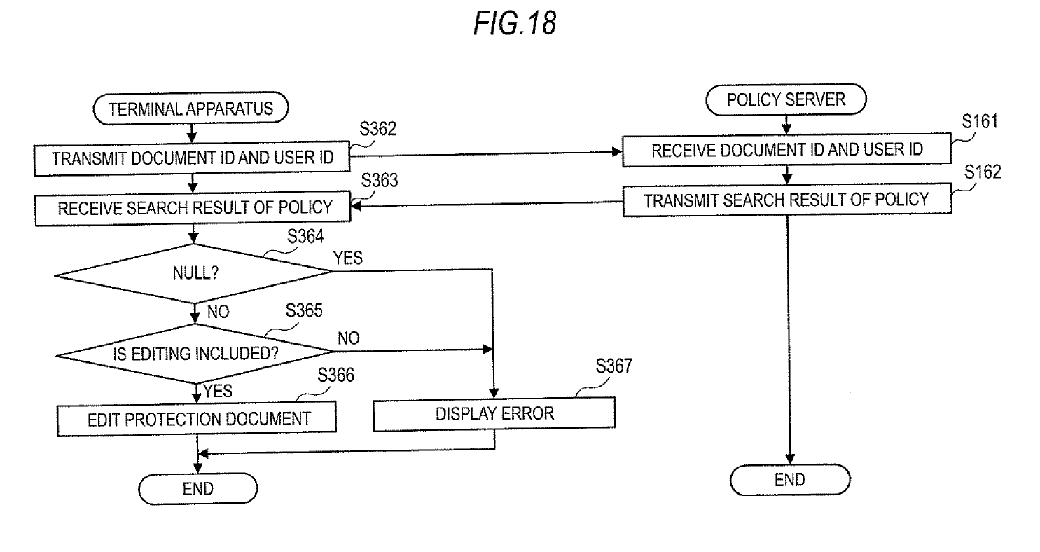

FIG. 18 is a sequence diagram illustrating information exchange between the terminal apparatus 30 and the policy server 10 when the user edits the secure document. It is assumed that, during editing, the secure document has already been opened by the document process AP. That is, the following sequence starts with the secure document being opened after the reading process shown in FIG. 17.

In the terminal apparatus 30, when there is a document editing request from the user, the secure document operating unit 32 calls the document search unit 14 of the policy server 10 using the document ID of the secure document and the user ID as parameters (Step 362).

Then, in the policy server 10, the document search unit 14 receives the document ID and the user ID (Step 161).

Then, the document search unit 14 searches for a record of the designated document ID from the document information DB 13, and sends back the search result to the terminal apparatus 30 (Step 162). Specifically, the document search unit 14 searches for a record of the designated document ID from the document information DB 13, and acquires the policy ID included in the record. Then, the document search unit 14 searches for a record of the policy ID from the policy DB 12, and extracts an operation permitted to the designated user, among the operations permitted to each user. In this case, it is determined whether the designated user ID is identical to the creator ID of a target secure document for an entry in which the user is a ‘creator’. If it is determined that the designated user ID is identical to the creator ID, the permitted operation in the entry is also extracted. When the permitted operation is extracted, the extracted result is sent back. When the permitted operation is not extracted, NULL is sent back.

Then, in the terminal apparatus 30, the secure document operating unit 32 receives the search result from the policy server 10 (Step 363) and determines whether the search result is NULL (Step 364).

As a result, if it is determined that the search result is NULL, the secure document operating unit 32 displays, for example, an error message indicating that ‘there is no access authority to the designated document’ on the display mechanism 30g since the operation of the designated secure document is not permitted (Step 367). Then, the process ends.

On the other hand, if it is determined that the search result is not NULL, the secure document operating unit 32 determines whether ‘editing’ is included with reference to the permitted operation items included in the search result (Step 365). If it is determined that ‘editing’ is not included, the secure document operating unit 32 displays an error indicating that ‘there is no authority to edit the designated document’ (Step 367), and the process ends. If it is determined that ‘editing’ is included, it is determined that there is authority to edit the designated document. Therefore, the secure document operating unit 32 permits the editing of the document by the user such that the user can edit the document (Step 366).

The operation of this exemplary embodiment has been described above.

In this exemplary embodiment, the stamp DB 11, the policy DB 12, and the document information DB 13 are managed by the policy server 10, but the invention is not limited thereto. For example, some or all of the databases may be managed by another server computer. Alternatively, some or all of the databases may be managed by the image processing apparatus 20. According to this structure, the document search unit 14, the policy search unit 15, the stamp discrimination unit 16, the stamp update unit 17, the stamp registering unit 18, and the document registering unit 19 provided in the policy server 10 are incorporated into the image processing apparatus 20. In this case, the image processing apparatus 20 is an example of the process determining apparatus, the stamp extracting unit 24 is an example of the instruction image acquiring unit that acquires an instruction image, and the stamp discrimination unit 26 (which includes the function of the stamp discrimination unit 16 provided in the policy server 10 in the above description) is an example of a determining unit that determines the process allocated to the registered image which is similar to the instruction image as a process to be performed on the document image.

In this exemplary embodiment, a process of giving the security policy to the document image is given as an example of the process that is performed on the document image read from a medium, but the invention is not limited thereto. For example, the following processes may be performed: a process of giving another facsimile number to document data generated from the document image which is read from a medium according to the recognition result of the stamp; a process of transmitting document data to another e-mail address; a process of storing document data in another folder of an external document management system; and a process of transmitting document data to another workflow.

In this exemplary embodiment, a stamp image, which is an imprinted image, is given as an example of the instruction image for instructing a process for the document image read from the medium. However, an image printed by a printer may be used as the instruction image. In addition, the instruction image may be given separately from the document image, instead of reading an overlap image between the instruction image and the document image and extracting the instruction image from the overlap image.

In the specification, the document image is printed on a medium. However, the document image does not mean only the image of a ‘document’ including text. For example, the ‘document images’ include images, such as pictures, photographs, and figures, images generated by database management software or table calculation software, and other printable images.

In addition, the medium having the document image printed thereon may be made of any material as long as images can be formed on the medium. A representative example of the medium is a sheet, but wood or cloth may be used as the medium.

A program for implementing this exemplary embodiment may be provided by a communication unit, or it may be stored in a recording medium, such as a CD-ROM, and then provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the skilled in the art to understand the invention for various embodiments and with the various modifications as are suited to the particular use contemplated. It is intended that the scope of the invention be defined by the following claims and their equivalents.

What is claimed is:

1. A process determining apparatus, comprising:
an instruction image acquiring unit that acquires an instruction image for instructing a process to be performed on a document image read from a medium having the document image formed thereon; and
a determining unit that, when the instruction image acquired by the instruction image acquiring unit is not identified with any of a plurality of registered images to which processes are allocated, determines a process allocated to one of the plurality of registered images that is similar to the instruction image as the process to be performed on the document image read from the medium.

2. The process determining apparatus according to claim 1, further comprising:
a presentation unit that presents information of at least one process allocated to at least one of the plurality of registered images which is similar to the instruction image,
wherein the determining unit determines a process selected by an operator among the at least one process whose information is presented by the presentation unit as the process to be performed on the document image read from the medium.

3. The process determining apparatus according to claim 1, further comprising:
a registering unit that allocates the instruction image to the process allocated to the registered image which is similar to the instruction image and registers the instruction image.

4. The process determining apparatus according to claim 1,
wherein the process includes a process of providing the document image with use restriction information that defines restrictions on a use of the document image.

5. The process determining apparatus according to claim 1,
wherein the instruction image includes an imprinted image that is formed on the medium having the document image printed thereon.

6. The process determining apparatus according to claim 1, further comprising:
a document image acquiring unit that acquires the document image read from the medium; and
a processor that performs the process determined by the determining unit on the document image acquired by the document image acquiring unit.

7. An image processing apparatus comprising:
a read unit that reads an image including a document image and an instruction image for instructing a process to be performed on the document image from a medium having the image formed thereon;
an acquiring unit that acquires the instruction image included in the image read by the read unit;
a display that, when the instruction image acquired by the acquiring unit is not identified with any of a plurality of registered images to which processes are allocated, displays information of at least one process allocated to at least one of the plurality of registered images which is similar to the instruction image;
a determining unit that determines a process selected by an operator among the at least one process whose information is displayed by the display as the process to be performed on the document image which is included in the image read by the read unit; and
a processor that performs the process determined by the determining unit on the document image which is included in the image read by the read unit.

8. A process determining system comprising:
an image reading apparatus that reads an image including a document image and an instruction image for instructing a process to be performed on the document image from a medium having the image formed thereon; and
a management apparatus that manages a plurality of registered images to which processes are allocated,
wherein the image reading apparatus transmits to the management apparatus the instruction image which is included in the image read from the medium,
when the instruction image transmitted by the image reading apparatus is not identified with any of the plurality of registered images, the management apparatus transmits to the image reading apparatus information of at least one process allocated to at least one of the plurality of registered images which is similar to the instruction image, and
the image reading apparatus determines a process selected by an operator among the at least one process whose information is transmitted by the management apparatus as the process to be performed on the document image which is included in the image read from the medium.

9. A computer readable medium storing a program causing a computer to execute a process for determining a process, comprising:
acquiring an instruction image for instructing a process to be performed on a document image read from a medium having the document image formed thereon; and
determining, when the instruction image is not identified with any of a plurality of registered images to which processes are allocated, that a process allocated to one of the plurality of registered images that is similar to the instruction image as the process to be performed on the document image read from the medium.

10. A method for determining a process, comprising: acquiring an instruction image for instructing a process to be performed on a document image read from a medium having the document image formed thereon; and
determining, when the instruction image is not identified with any of a plurality of registered images to which processes are allocated, that a process allocated to one of the plurality of registered images that is similar to the instruction image as the process to be performed on the document image read from the medium.
